(19) United States
(12) Patent Application Publication
(10) Pub. No.: US 2007/0083442 A1
(43) Pub. Date: Apr. 12, 2007

(54) METHOD, SYSTEM AND PROGRAM PRODUCTS FOR BATCH AND REAL-TIME AVAILABILITY

(75) Inventors: Daniel J. Peters, Poughquag, NY (US); Thomas E. Benton Jr., Raleigh, NC (US); Kenneth M. Cyprys, Chappaqua, NY (US); Joseph P. DeMarco, Newburgh, NY (US)

Correspondence Address: LAW OFFICE OF DELIO & PETERSON, LLC., 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 11/163,228

(22) Filed: Oct. 11, 2005

(51) Int. Cl. G07F 7/00

(52) U.S. Cl. 705/27

(57) ABSTRACT

Methods, systems and program products for providing automated and consistent sales offerings availability messages, whereby a user type is identified, a catalog appropriate for such user type is provided and then a quantity of a sales offering is selected from the catalog. Availability data feeds are provided that may include real-time availability data feeds, batch availability data feeds, and combinations thereof. The user type and availability data feeds are then used to generate a sales offering availability message for the selected quantity of sales offering. The generated sales offering availability message is then transmitted to a commerce component for viewing, whereby the sales offering availability message may be viewed by and customized to user types including customers, business partners, distributors, internal sales and administrative support staff. Depending upon the user type, the sales offering availability message is viewed in a display showing lead time availability or supply line availability.

### BACKGROUND OF THE INVENTION

1. Field of the Invention

The present invention relates to displaying product and service availability by providing integrated methods, systems and program products for providing consistent availability messages to differing audiences that can be updated via batch feeds or in real-time.

2. Description of Related Art

In today's competitive environment, companies are looking beyond product and price to develop an edge on their competitors. Providing information about the availability of a product has become one of the major influencers in the buying decisions of customers. Many companies provide availability information to customers based on batch files that are updated daily, or perhaps more frequently throughout the day. It is also known to provide availability information updates based upon a change in the supply information that cause a change to the availability date. However, since there is currently no precise way to know in advance how many of a particular item a customer is considering buying, the customer may order a large quantity based on the availability information displayed. For instance, the availability information can be displayed as based on an order of one or a quantity based on a statistical probability. As such, these methods can lead to inaccurate results and dissatisfaction to customers regardless of the number of times that the information is updated throughout the day.

The pressure on companies to reduce costs has also impacted the way availability information is calculated and displayed. Manufacturers must keep their supply of materials at a component or building block level in order to provide the most flexibility in producing the various configurations of products that the customers require, while also trying reducing inventory costs. This change from stocking material as finished goods or build-to-plan to an assemble-to-order modality has increased the complexity of calculating and displaying the availability of such products. Further, instead of calculating availability based on whether the product is in stock or on order, the calculation must now also determine what components are in the product, the number of such components available, and the number of products can be derived from those available components. However, since many products can utilize the same components within their product builds as other products, the batch update of availability information becomes even less accurate.

Currently, availability information displayed on the web or to an entitled customer, non-entitled customer, Business Partner, or internal sales staff and administrative support is generally represented as a lead-time message. However, such displays are undesirable since they do not provide the flexibility to analyze the entire supply outlook for making informed decisions on what is the constraining component and whether an alternative solution with a different component would provide an improved delivery or arrival date.

Accordingly, a need exists in the art for providing the most up to date availability information that is at a detailed level for allowing a user to make knowledgeable, informed decisions.

### SUMMARY OF THE INVENTION

Bearing in mind the problems and deficiencies of the prior art, it is therefore an object of the present invention to provide methods, systems and program products for providing an immediate static default batch view of lead time availability for products and services, along with a real-time view of availability for such products and services for allowing a user to make knowledgeable, informed decisions during the learn, shop and buy experience.

It is another object of the present invention to provide methods, systems and program products that distinguish availability information based on user type and customer tier by providing batch and real-time views of availability based on user types and customer tiers at key points during the learn, shop and buy experience.

Another object of the present invention is to provide methods, systems and program products that provide a scheduling application as a single source for generating availability information based on user type and business rules.

A further object of the invention is to provide methods, systems and program products that provide a view of available finished goods inventory held at distributor locations to the internal sales and administrative support audience.

It is yet another object of the present invention to provide methods, systems and program products for providing net available supply quantities over a predefined time horizon to business partners and internal sales and administrative support audiences.

Yet another object of the present invention is to provide methods, systems and program products that promote customer satisfaction by setting proper expectations, as well as provide a competitive advantage to the internal sales and administrative support audience by leveraging availability information for completing a sale.

Another object of the present invention is to provide methods, systems and program products that serve as a base for up-sell, alternative-sell, down-sell and cross-sell opportunities.

Still other objects and advantages of the invention will in part be obvious and will in part be apparent from the specification.

The above and other objects, which will be apparent to those skilled in art, are achieved in the present invention, which is directed to in a first aspect a method for providing sales offerings availability messages. The method includes identifying a user type, providing a catalog appropriate for such user type, and selecting a quantity of a sales offering from such catalog. Availability data feeds are provided, and then a sales offering availability message is generated for the selected quantity of the sales offering by utilizing the user type and the availability data feeds. This sales offering availability message is transmitted to the commerce component for viewing.

In accordance with the invention, the user type may include a non-entitled customer, an entitled customer, a business partner, a distributor, an internal sales or an administrative support staff. The non-entitled customers are able to view a public catalog, whereas the entitled customer, business partner, internal sales and administrative support staff are able to view both entitled catalogs and public catalogs. Further, the business partner, internal sales and administrative support staffs are able to view net available supply lines (net available supply quantities) over a seller's supply planning horizon, while the internal sales and administrative support staffs are further able to view a source of supply indicator, in addition to net distributor Finished Goods Inventory quantities at distributor locations.

In this aspect of the invention, wherein the catalog is provided over a Web, a user views the catalog on the Web, selects the quantity, and views the sales offering availability message based on the user type of such user. Alternatively, wherein the catalog is provided by telesales, a telesales representative views an appropriate catalog based on the user type for assisting a user of such user type. In this aspect, the user determines the quantity to select from the catalog, and the telesales representative views the sales offering availability message in the commerce component and then communicates the sales offering availability message to the user.

The sales offering may be a product, a service or even combinations thereof. The availability data feeds may be real-time availability data feeds, batch availability data feeds, and combinations thereof. Depending upon the user type, the sales offering availability message is viewed in a display showing lead time availability or supply line availability (net available supply quantities).

Still further in this aspect, the step of generating the sales offering availability message may further include requesting an availability message of the selected quantity of the sales offering, and then determining a schedule date in response to the request using the availability data feeds. This schedule date is then converted into the sales offering availability message. In so doing, the availability message of the selected quantity of the sales offering is preferably requested within a commerce component. This request is then transmitted from the commerce component to a scheduling component. The availability data feeds are also received within the scheduling component. The schedule date is determined within the scheduling component using the availability data feeds, and then transmitted to the commerce component. Once therein, the commerce component converts the schedule date to generate the sales offering availability message.

The method for providing sales offerings availability messages may also include the steps of configuring a customized solution for the sales offering availability message, as well as checking for an availability message of all sales offering availability messages stored within a shopping cart just prior to making a purchase.

In another aspect, the invention is directed to a system and a program storage device capable of carrying out the methods described herein.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a diagram illustrating the system architecture upon which batch and real-time availability is implemented in accordance with the invention.

FIGS. 2A-2E is a preferred embodiment of the process flow of the invention for providing batch and real-time availability messages integrated across all audience types.

FIG. 3 is a diagram illustrating batch availability messages for all audiences in accordance with the invention.

FIG. 4 is a diagram illustrating the entitled and non-entitled customer view of availability in accordance with the invention.

FIG. 5 is a diagram illustrating the business partner view of availability in accordance with the invention.

FIG. 6 is a diagram illustrating the internal sales staff and administrative support view of availability in accordance with the invention.

### DESCRIPTION OF THE PREFERRED EMBODIMENTS

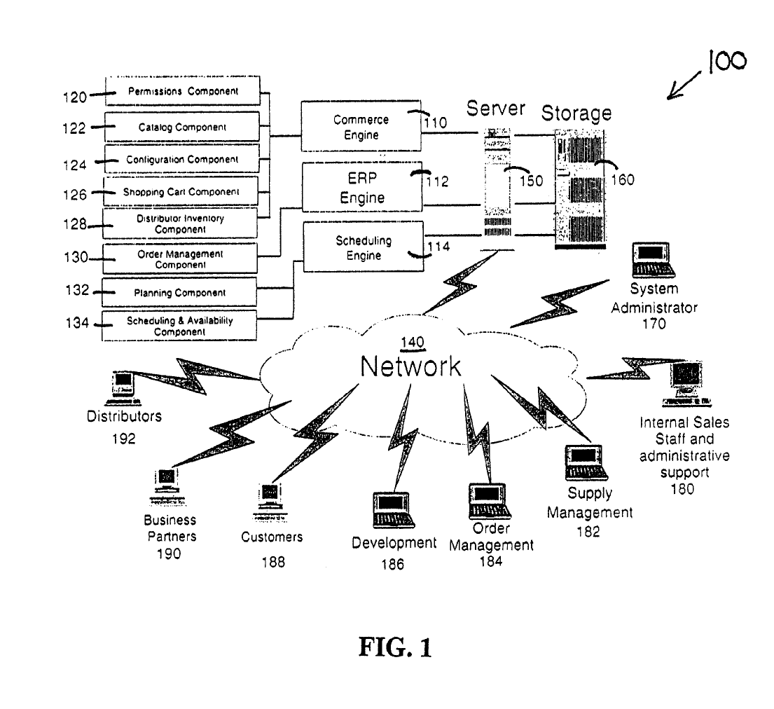

In describing the preferred embodiment of the present invention, reference will be made herein to FIGS. 1-6 of the drawings in which like numerals refer to like features of the invention.

Definitions relevant to the present invention are as follows:

User. A user of the invention may be a public customer, an entitled customer, a business partner seeking to make a purchase, a distributor, and/or seller's internal sales staff and administrative support assisting in the making of a purchase.

Public Customer. A public customer (non-entitled) is a user who does not have a contractual relationship with the seller. These customers normally shop anonymously until they are prepared to buy. The public customer is unknown until the customer provides “ship to” and “payment” information to the seller (or registers on-line). The presentation of availability to a public customer is expressed as a lead-time message.

Entitled Customer. A customer is a user who has a special relationship with the seller, such as products, services, availability, and pricing. Normally, this customer prefers a reduced version of the seller's catalog based on the contractual relationship between the customer and seller, specifically those products and services that have pricing discounts and service level agreements. In some instances, the entitled customer is provided relationship pricing (i.e., a percentage reduction) on the remainder of the seller's catalog. Entitled customers are required to identify themselves during the learn, shop and buy experiences to view their contractual entitlements. The presentation of availability to an entitled customer is also expressed as a lead-time message; however, the entitled customer's lead time availability message may be less than the public customer's lead time availability message due to customer tiering within the scheduling engine or application.

Business Partner. A business partner is an intermediate sales conduit between the seller and a customer. The business partner enjoys a formal, contractual relationship with the seller, and sometimes with the customer. The contractual relationship with the business partner includes discounted pricing, and other terms and conditions of mutual benefit. The business partner will normally provide some profile information that can be used in segmentation and analysis. The business partner has access to more information than a customer would see, but less than the seller' internal sales staff and administrative support. An example of a proprietary supplier and customer information that business partners may not be privy to are sources of product supply.

Distributor. A distributor is a special category of business partner who can add value to products, support other business partners and customers, and can be a source of supply or fulfillment center for the seller.

Internal Sales Staff and Administrative Support. The internal sales staff and administrative support is comprised of the seller's face-to-face sales (e.g., staff to one customer or business partner, or an account representative with more than one customer or business partners), Technical Sales Support (i.e., service consultants, sales support, web services, etc.), administrative support personnel, and/or TeleSales Representatives. The seller's internal sales staff can view customer, business partner and seller's information completely based upon satisfactory log-in to a proprietary commerce application.

Customer Tiering. A method to differentiate customers into groups (tiers) in order to provide a different level of service based on their importance to the business. For example, supply capabilities are allocated to different tiers, which may result in different availability lead times.

Learn. The user is browsing a catalog (e.g., an on-line catalog or a physical catalog) looking for suitable products, services or options. In the case of products or services, the user may be seeking a suitable starting point for the shop experience (i.e., configuration). During the learn experience, the user may view the availability of the selectables, either in batch mode or real-time availability. If the product, service or option is satisfactory “as is,” the user goes straight from the learn step to the buy experience.

Shop. The user is customizing (configuring) a product or service based on selectables and options that are part of the offering. During the shop experience within the sales configurator, the user may view the availability of the selectables, either in batch mode or real-time availability, whereby once the user (particularly, the customer, business partner, or distributor) is satisfied with the function, price and availability, they may proceed to the buy experience.

Buy. Once the user has made their selections from the learn and/or shop experiences, such selections are viewed within a purchase list typically displayed in a shopping cart. At this point, the user has several options within the buying experience including, but not limited to, saving the shopping cart, selecting premium transportation, continue browsing or configuring, and the like. During the buy experience within the shopping cart, the user may view the availability of the selectables, either in batch mode or real-time availability. For example, the decision to select premium transportation may be based on real-time lead time to arrival information.

Products. A manufactured tangible entity that has economic utility, satisfies an economic want, or possesses intrinsic value (excluding financial instruments) that is available for monetary or other compensation.

Services. A useful labor or activity such as, for example, a warranty, post sales support, consulting, training, transportation, managed operations and the like. A service may be available for monetary or other compensation.

Options. An option is a complementary product or service that completes a solution. Examples are accessories, peripherals, warranties, shipping and service packages. Options are part of the cross-selling sub process at the end of the shop and buy processes.

Commerce Engine. A web based application that provides users with the ability to view products and services (pictures and descriptions), obtain prices and purchase products and services on line.

Ordering Methods. The numerous available methods of ordering products and services including, but not limited to, via the Internet, through telesales, facsimile, telephone, and the like.

Methods of Scheduling. The scheduling method can be based on lead time, supply line, or manual calculations and used to obtain a delivery date or ship date for a product or service.

Availability. Availability is expressed as a message, usually as a lead time in days (either to ship or arrival) based on the seller's scheduling engine, planning component, scheduling and availability component, and business rules. Examples of lead time availability messages are: “5 days”, “3 weeks”, “in Stock”, “Within 2 weeks”, “one to two weeks”, “contact the seller”, etc. Some considerations in determining availability are source of supply, quantity, and type of availability presentation (batch or real-time). The selection of “ship” or “arrival” lead times is based upon seller's business practices and the scheduling application. The view of availability may vary depending on the audience.

Batch Availability. A batch feed may be used to update availability information for products and services within the commerce engine. The availability may be based on a quantity of one, or on a current statistical rate. This batch update may occur one or more times throughout the day.

Real-Time Availability. An availability response that is provided substantially in real-time, commonly within seconds, to the requester to identify when a specific quantity of selected products or services will be shipped or delivered.

Net Available Supply. The remaining amount of supply available for customers to purchase over time after the current order backlog is subtracted from an initial supply position.

Supply Line Availability Information. A display of net available supply over the planning horizon time period which can be viewed by business partners and internal sales and administrative support staffs. Supply line availability information is displayed as a series of quantities in seller specified time frames i.e., days, weeks, months, etc. or combination thereof.

Availability Messages. Textual information presented to a user representing availability information. It is converted from a schedule date to when a product is going to be shipped or delivered, and may be in the form of a numeric or text lead time.

Lead time to shipment. An availability message describing the lead time (e.g., days or weeks) for shipping a product or service from the provider. When days are used, the seller needs to specify calendar or work days.

Lead time to arrival. An availability message describing the lead time (e.g., days or weeks) for delivering a product or service from the provider to the buyer. When days are used, the seller needs to specify calendar or work days.

Methods of delivery. The vehicle by which the product or service is delivered to the buyer. For example, standard delivery, premium transportation, software download, etc. The mode of delivery is one factor in determining the lead time to arrival availability message.

The present invention is directed to integrated methods, systems and program products for providing automated and consistent presentation of availability messages for sales offerings, and integrates such messages across all routes to market including, but not limited to, telephone sales (“TeleSales”), web sales (“Web”), channels (e.g., business partners and distributors), sales account teams, and the like. In accordance with the invention, the sales offerings may include products, services and even combinations thereof. The sales offering availability messages may be displayed to users of the invention who may include, but are not limited to, customers, business partners, distributors, internal sales and administrative support staff, and the like.

An essential feature of the invention is a scheduling engine that presents availability messages to users throughout the learn, shop and buy experiences. Advantageously, these availability messages are displayed to users during the learn experience, wherein the user may be browsing a catalog and needs to know the most current available quantities of a particular item. The user is allowed to view the availability message of the invention, along with the function and price of such item. In accordance with the invention, the availability messages derived from the scheduling engine are generally displayed to users as a lead time message, and may be updated either via batch data feeds or in real-time data feeds.

The present invention is sufficiently robust to handle dynamic business environments, and is portable across business models, business units, products and services. The impact of this invention is to have consistent availability messages across all routes to market when customers, business partners, distributors and seller's internal sales and administrative support staffs want them. The method relates to demand management, order management, sales, development, supply management, Internet operations, Web operations, channel operations, manufacturing, and consultancy fields.

For ease of understanding the invention, reference is now made to FIG. 1 depicting a preferred embodiment of the system architecture 100 of the invention for implementing batch and real-time availability messages in accordance with the invention. The system architecture 100 preferably includes a network server 140 for executing a Commerce Engine 110, an Enterprise Resource Planning (ERP) engine 112, and a Scheduling Engine 114 using a variety of automated input components including, but not limited to, a Permissions component 120, a Catalog component 122, a Configuration component 124, a Shopping Cart component 126, a Distributor Inventory component 128, an Order Management component 130, a Planning component 132, and a Scheduling & Availability component 134. As is shown, the Commerce Engine 110, ERP engine 112, and Scheduling Engine 114 are in communication with server 150, storage system 160 and the network server system 140.

Network 140, or a number of networks, connects a number of client systems 170-192 to the Server 150, which is also connected to a storage system 160. Each network may comprise a Local Area Network (LAN), a Wide Area Network (WAN), Internet or other network configuration known in the art. These networks may be connected to each other in a state of the art configuration. Further, the network may include wireless connections, radio based communications, telephony based communications, and other network-based communications. Secure Socket Layer (SSL encryption) software may be used to control access to server system, limiting permissions to network users, such as remote client systems or vendor systems that have proper authorization.

The Server 150 may also operate as an application server, whereby it executes one or more computer programs to implement the invention. As previously described, it is understood that separate servers may be utilized to implement the network server functions and the application server functions. Alternatively, the network server, the firewall, and the application server may be implemented by a single server executing computer programs to perform the requisite functions.

For example, the server 150 may include, but is not limited to, an IBM® eServer (iSeries™, pSeries™, xSeries™ or zSeries™) or any other commercially-available computer system suitable for the scope of implementation in accordance with the invention. The Server may execute web server software designed to accommodate various forms of communications, including voice, video, and text typically utilized by large business enterprises. Any web server software or similar program that handles general communications protocols and transport layer activities could be used as appropriate for the network protocol in use. For instance, the server may run IBM's Lotus Domino™ and Lotus Notes™ as its groupware applications software; however, any compatible e-mail-integrated, web-enabled collaborative software could be used.

The storage device or system 160 may be implemented using a variety of devices known for storing electronic information. It should be understood that the storage device 160 may be implemented using memory contained in the server, or alternatively, it may be a separate physical device. The storage device 160 is logically addressable as a consolidated data source across a distributed environment that includes a network. Information stored in the storage device 160 may be retrieved and manipulated via the server by a database manager and data mining software. For purposes of illustration, the database manager may be IBM's DB/2 software. The storage device 160 includes a data repository containing documents, data, web pages, images, multimedia, etc. Further, storage device stores configuration files (also referred to herein as page tokens).

The storage device 160 may comprise any form of mass storage device configured to read and write database-type data maintained in a file store (e.g., a magnetic disk data storage device). The storage device can range from a single Hard Disk Drive on a personal computer to large enterprise storage systems, i.e., IBM's Shark™. Of course, it should be understood that the storage device may be one that consists of multiple disk subsystems which may be geographically dispersed and coupled via network architecture. The implementation of local and wide-area database management systems to achieve the functionality of the storage device will be readily understood by those skilled in the art.

In accordance with the invention, the Commerce Engine 110 is a web based application that provides users of the system with the ability to view products and services (e.g., pictures and descriptions), obtain prices and purchase products and services on line. The users may include customers (i.e., both entitled and non-entitled customers) 188, business partners 190, distributors 192, and internal sales staff and administrative support 180 (hereinafter collectively referred to as “users”). The Commerce Engine is managed by internal sales staff and administrative support 180, and it includes and receives input from five distinct components, namely, the Permissions component 120, Catalog component 122, Configuration component 124, Shopping Cart component 126, and the Distributor Inventory component 128.

In particular, the Permissions Component 120 is for the users to log in and enter a password into the commerce engine. It is managed by Internal Sales Staff & administrative support 180, and enables providing the appropriate entitled data to specific users.

The Catalog Component 122 is used to provide sales offering information, with includes products and/or services information, during the learning experience for users, which is provided and managed by Development 186. This sales offering information is transmitted from the catalog component out to the configuration component 124 or the shopping cart component 126. An essential feature is that batch and/or real-time availability data is provided from the Scheduling & Availability application component 134 to the catalog component.

The Configuration Component 124, which is devised and managed by Development 186, customizes products and service offerings during the shop experience by tailoring such offerings to the particular user type and needs of such user type. An essential feature is that batch and real-time availability data is provided from the Scheduling & Availability application component 134 to the configuration component 124 for customizing these products and service offerings based on user type. The products and/or services sales offerings are processed through the configuration component, and are transmitted from the catalog component 122 to the shopping cart component 126.

The shopping cart component 126, which is managed by Internal Sales Staff & administrative support 180, holds and submits order entry information during the user's buy experience. The shopping cart receives ordering fulfillment data including, but not limited to, payment method, ship to address, billing, etc. The shopping cart also receives batch and real-time availability data from the scheduling application component 134 for completing the order in the ERP Engine 112.

The Distributor Inventory component 128 of the present system receives product availability information on a periodic basis from distributors 192. This product availability information is transmitted to the commerce engine by Internal Sales staff and administrative support 180 for satisfying order requirements from customers 188 (i.e., both entitled and non-entitled) and business partners 190. At this point, the seller can either redirect the order to the distributor or can buy back the product from the distributor.

The ERP Engine 112, which is controlled by Order Management 184, automatically manages the enterprise functions involved with the order management component 130, which is also maintained by Order Management 184. In so doing, order fulfillment information is transmitted from the Order Management component 130 to the ERP Engine 112 for production and fulfillment processing, whereby the ERP Engine then passes key order attribute information to the scheduling engine 114 and the Commerce Engine 110. This order fulfillment information includes all order transactions and the management of the order from order entry through installation. As such, the Order Management component controls the order information flow between the Commerce Engine, ERP Engine and the Scheduling Engine.

The Scheduling Engine 114 is an automated system that receives key order attribute information from the ERP engine 112. The Scheduling Engine 114 is managed by Supply Management 182 and is in direct communication with the Planning Component 132 and Scheduling & Availability component 134, both of which are maintained by Supply Management 182 and are automated systems.

In accordance with the invention, the Planning component 132 provides the initial supply position to the Scheduling Engine 114, which is communicated by suppliers to the seller based on the demand forecast. In so doing, customers, distributors and business partners may be assigned to tiers based on seller prioritization rules (e.g., customer tiering, allocations, brokering schema, etc.), while net available supplies are allocated based on business practices (e.g., geographies, customers, tiers, etc.).

The Scheduling & Availability component 134 is updated on a periodic basis based on the net available supplies and the scheduling engine's 114 business rules (e.g., customer tiering, allocations, brokering schema, etc.) for determining the products and/or services sales offering availability. The Scheduling & Availability component may be updated on a batch basis (e.g., one or more times per day) or in real-time during the learn, shop and buy experiences. Using this updated products and/or services sales offering availability information, an availability statement is generated that follows the rules of scheduling, and will be expressed as a lead time, consistently either lead time to ship or lead time to arrival.

Client systems 170-192 comprise known computer devices that allow systems to connect to the network and host system. Client systems may access the host via internal web browsers. Individual client systems are described below, and may include suitable computer systems. Individuals and teams involved in the selling, marketing and merchandising products or services perform specific roles throughout the described process. They are also in communication with each other via client systems as will be described further herein.

The System Administrator 170 refers to a client system operated by individuals or teams that manage the performance, operation, and maintenance of the server 150, storage system 160 and network 140.

The Internal Sales Staff and Administrative Support 180 control and manage both the Permissions component 120 and the Shopping Cart Component 126 for ensuring that users view only pertinent information within the Commerce engine 110 applications. It also controls the Distributor Inventory Component 128 to include receiving and viewing permission, as well as allows entering of orders by using the catalog, configuration and shopping cart components. The Internal Sales Staffs and Administrative Support 180 have a fully authorized view of availability information including source of supply, distributor inventory and seller's supply quantities over a certain time horizon.

The Supply Management 182 controls and manages the Scheduling Engine 114, the Planning Component 132 and the Scheduling & Availability component 134, which includes the development of net available supply, allocations, etc.

The Order Management 184 controls and manages both the ERP engine 112 and the Order Management component 130 for receiving orders from the shopping cart 126 and transmitting such data to the Scheduling Engine 114.

Development 186 creates the seller's offerings that reside in the Catalog component 122. These seller's offerings are based on approved products and/or services sales offering structures, whereby items within such structures that have alternative capabilities may be modified in the Configuration component 124. It should be appreciated that the development team is responsible for the data and systems that support the learn and shop experiences.

The remaining components are a subset of the users of the invention, namely, Customers 188, Business Partners 190, and Distributors 192. Each of such users is able to enter orders by using the appropriate catalog for the particular user type, the configuration component and the shopping cart component.

Customers 188 view availability messages throughout the learn, shop and buy experience based on lead times and customer tiering. The public customers (i.e., non-entitled customers) are able to view the entire seller's public catalog of products and services, whereas entitled customers can view the seller's public catalog or a customized catalog that displays entitled prices and improved availability information based on tiering logic associated with the entitled customers. The Business Partners 190 also view availability messages throughout the learn, shop and buy experience based on lead times and customer tiering. However, Business Partners are able to view a seller's supply quantities over a given time horizon. Distributors 192 are also able to view availability messages throughout the learn, shop and buy experience based on lead times and customer tiering. The Distributors are able to view a seller's supply quantities over a certain time horizon, and are able to provide their Finished Goods Inventory (“FGI”) feeds on a periodic basis to the seller.

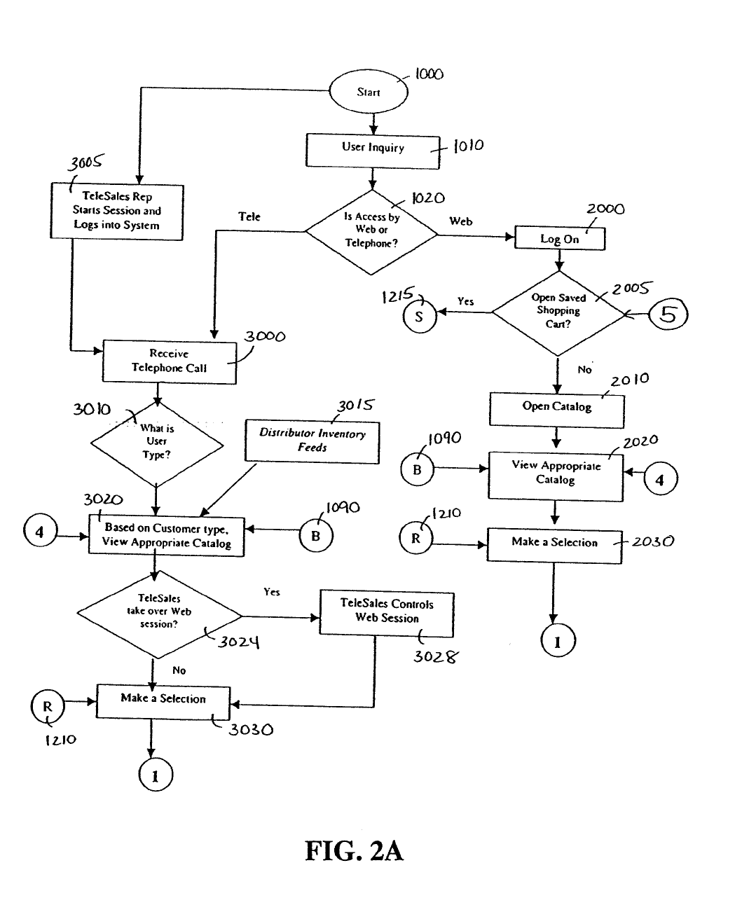

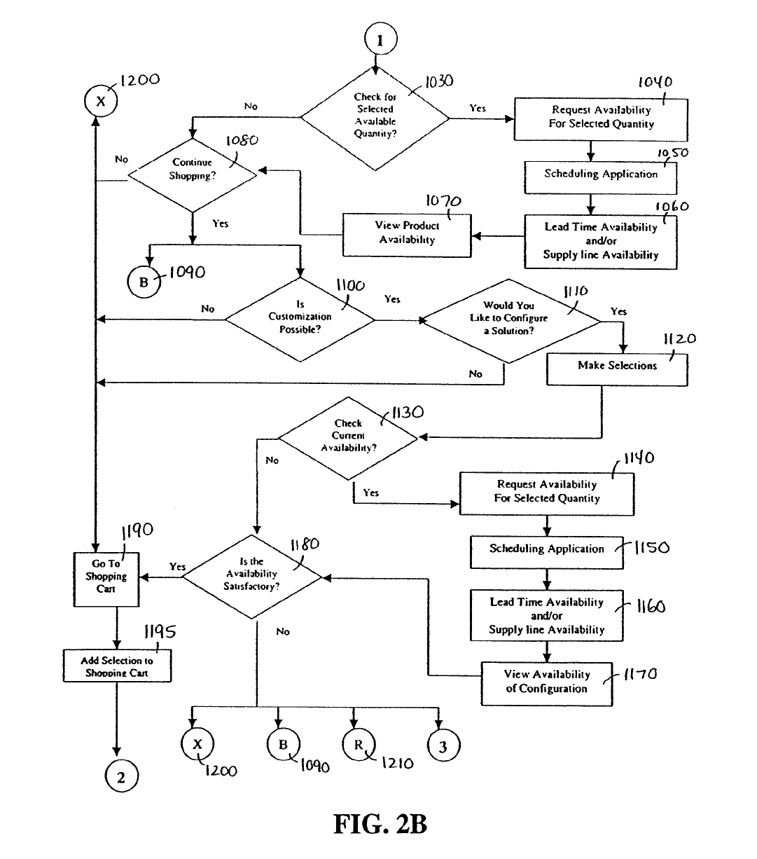

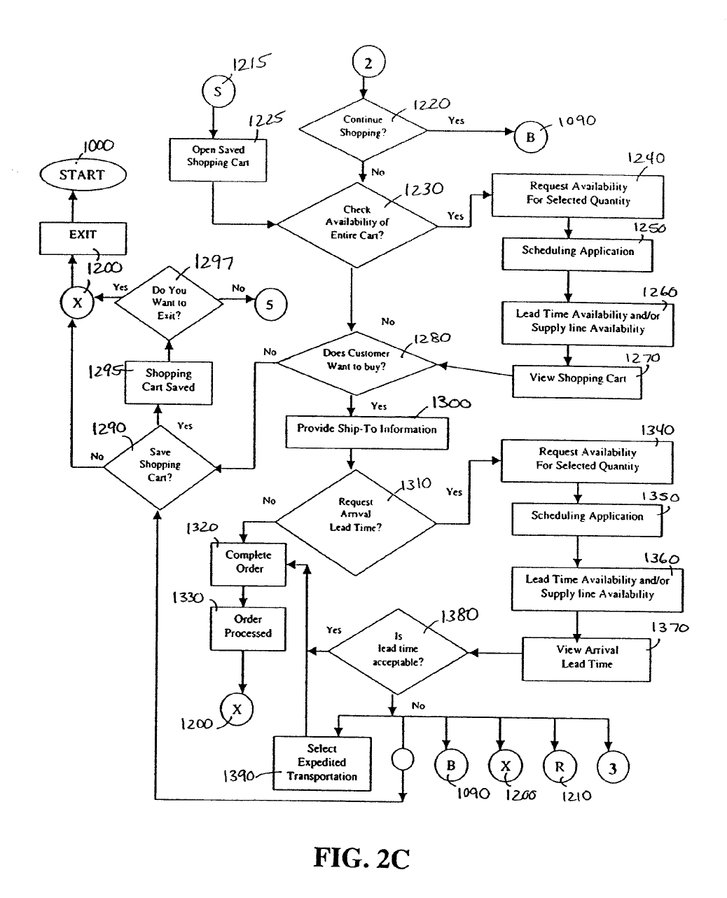

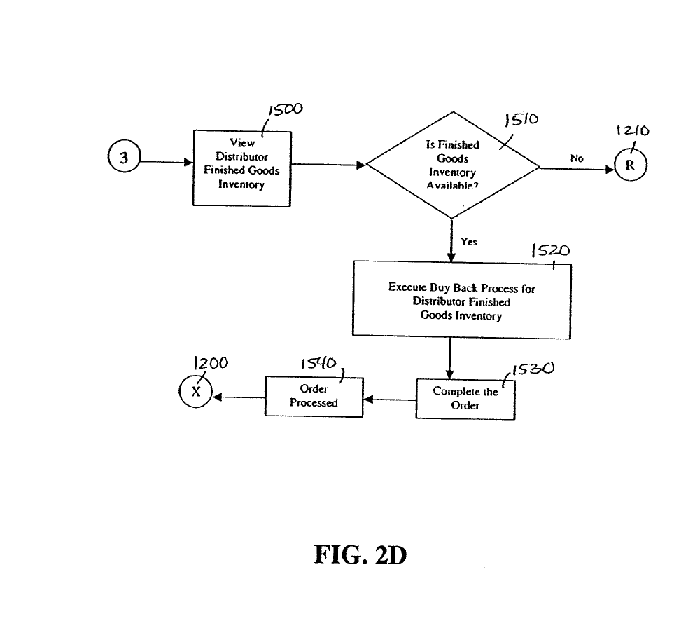

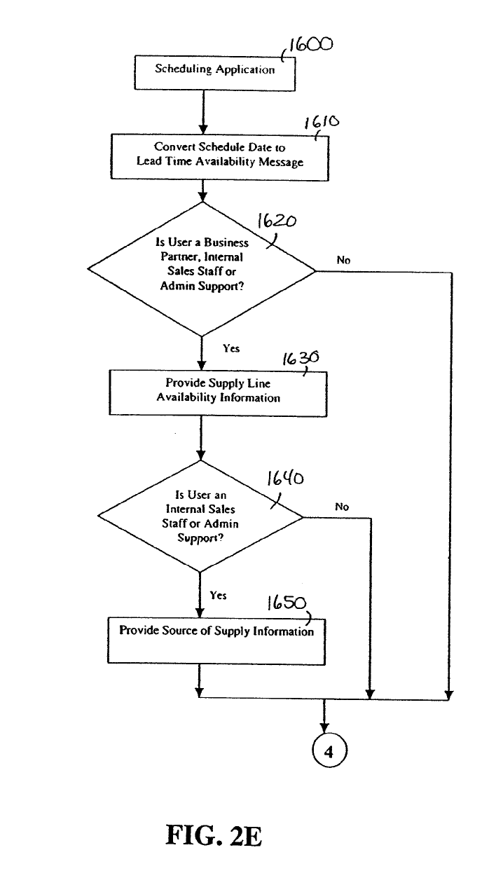

Referring to FIGS. 2A-2E, a process flow of the invention is shown for implementing batch and real-time availability messages in accordance with the invention.

Upon starting the present method, system and programs product (step 1000), a TeleSales Representative starts a session (step 3005) or a user makes an inquiry to a seller either by telephone or over a Web (step 1010), and it is then determined whether or not such inquiry is by telephone or a web (internet) (step 1020). If the commerce engine 110 determines that the inquiry is made by Web, then the process flow continues by the user logging onto the system (step 2000) through the permissions component 120. In so doing, the user type may be identified as an entitled customer, a non-entitled customer, a business partner, or internal sales staff and administrative support. In the telesales scenario, the telesales representative may be a sales staff, such as an internal sales staff, and/or an administrative support staff.

It is then determined whether or not the user would like to open a saved shopping cart (step 2005). If the user does not want to open a saved shopping cart, then the process flow continues to opening a catalog (step 2010). However, if the user would like to open a saved shopping cart, then the process flow continues to the shopping cart (step 1215) of FIG. 2C. Based on the identified user type, an appropriate catalog for such user type is opened (step 2010) from the catalog component 122 for viewing by the user (step 2020). The user may then make a selection for an item and a certain quantity of the selected item from the viewed catalog (step 2030). Availability information by audience is provided from FIG. 2E. The process flow proceeds to step 1030 of FIG. 2B.

However, if the commerce engine 110 determines that the inquiry is made by telephone (step 1020), the process flow continues by a TeleSales representative receiving the telephone call at a seller's call center (step 3000). This TeleSales representative has previously started and logged into the present system (step 3005). Once the telephone call has been received, the user type is identified (step 3010), and then based on the identified user type, an appropriate catalog with applicable offering, price and batch lead time availability information for such user type is opened for viewing (step 3020) from the catalog component 122. While this catalog is being viewed, distributor inventory feeds of Finished Goods Inventory (FGI) are simultaneously fed into the catalog for continually updating the availability messages (step 3015), as discussed in detail below. The distributor inventory of FGI may be fed into the catalog either in batch mode at periodic intervals throughout the learn, shop and browse experiences, or in real-time as updates currently become available.

In the TeleSales approach, once the TeleSales Representative views the appropriate catalog, it is then determined whether or not the TeleSales representative will take over the user's current session (step 3024). If the user is to maintain control, the user then makes a selection from the viewed catalog (step 3030). However, wherein the user does not want control, the TeleSales takes over control of the session (step 3028), and then a selection may be made from the viewed catalog for an item and quantity of such item (step 3030) and proceeds to step 1030 of FIG. 2B.

The catalog, or catalogs, that the user views from the catalog component 122 vary depending upon the identified user type (i.e., whether the user is an entitled customer, a non-entitled customer, a business partner, or internal sales staff and administrative support). In accordance with the invention, an entitled customer is able to view their entitled catalog, and optionally, a public catalog based on established permissions and/or restrictions as set forth in the contractual relationship between the entitled customer and seller. A non-entitled customer is only able to view a public catalog, which contains the list price and availability for all products and services provided by the seller within such catalog. A business partner can view both public and entitled catalogs, while the internal sales staff and administrative support user can also view both public and entitled catalogs in addition to viewing distributor Finished Goods Inventory (FGI) quantities held at the seller's distributor locations.

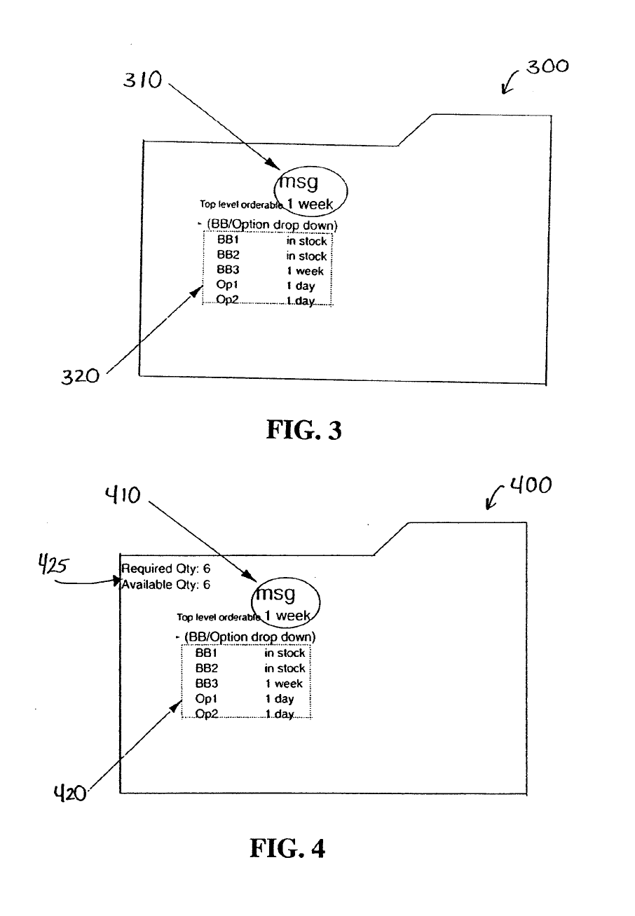

In accordance with the invention, the steps of making selections from the viewed catalogs includes users viewing an appropriate catalog based on user type from the catalog component 122, and making a selection of an item based on item function, price and batch availability, along with selecting a desired quantity of the item. That is, upon entering the present system, each user initially views a static display of availability that shows batch availability of the item for a quantity of at least one, or a seller specified statistical going rate (greater than one). For instance, FIG. 3 shows a display screen for batch availability of a product or service with a drop-down dialog box of the building blocks of the product or service. The user may then decide to check the requested, desired quantity of the selected item for availability (step 1030). In so doing, the user determines whether or not they want to view real-time availability for a desired quantity of one or greater. For instance, FIG. 4 shows a display screen of an entitled and non-entitled customer's view of real-time availability.

Wherein the selected quantity is to be checked for real-time availability for a quantity of one or greater, the process flow continues by requesting the availability for the selected quantity (step 1040). This request is input into the Scheduling & Availability component 134 (step 1050) for generating an availability message (step 1060) that is viewed by the user (step 1070). The availability message may be expressed as either lead time availability and/or supply line availability (net available supply quantities), whereby the ability to view such messages is dependent upon and controlled by the user type. For example, customers (both entitled and non-entitled) and business partners may view the availability message as lead time availability, while business partners and internal sales staff and administrative support may view the availability message as supply line availability and/or lead time availability.

All requests for real-time availability in accordance with the invention are accomplished by transmitting the request from the Commerce Engine 110 to the Scheduling Engine 114. The input data is processed within the Scheduling Engine, which returns a schedule date (e.g. to ship or arrival), preferably a best available schedule date, to the Commerce Engine 110. The Commerce Engine then converts the schedule date to a lead time in days based on the current date, and then translates such lead time to an availability message (e.g., “5 days”, “3 weeks”, “in stock”, “within one week”, “one to two weeks”, “call the seller”, etc.). The availability message may be generated based on a look up table that is maintained within the Commerce Engine.

In continuing the process flow of the invention, once the availability message is viewed by the user (step 1070), it is then determined whether the user would like to continue shopping based on the selected item, its price and the availability of the selected quantity of such item contained within the availability message (step 1080). Alternatively, if the selected quantity is not to be checked for availability (step 1030), the process flow may continue directly to the step of determining whether the user would like to continue shopping (step 1080). In the event the user does not want to continue shopping, the user may either exit the system (step 1200), or the process flow may continue by going to the shopping cart (step 1190).

Wherein the user would like to continue shopping after viewing the availability message (from step 1080), the user may either continue to browse the catalog (step 1090), or the user may customize the selection. In customizing the catalog selection, it must first be determined whether or not customization of the selected item(s) is even possible (step 1100). If it is not possible, the process flow continues directly to the shopping cart (step 1190). However, if it is determined that customization is possible, it must then be decided whether or not the user would like to configure a customization solution for the selected item (step 1110). It should be appreciated that the customized configuration may provide a solution that better fits the particular needs, wants and desires of the user.

In the event the user does not want to configure a customization solution, the process flow continues to the shopping cart (step 1190). If, however, the user would like to configure a customized solution for the selected items, the process flow continues by the user viewing other selectable items within the configuration component 124, and their corresponding batch availability. These other items may include products, services and even combinations thereof. The user may then make selections from these other items and specify a desired quantity of such items based on the items functions, prices and batch availabilities (step 1120). It is then determined whether or not the user would like to check for real-time availability (step 1130). If the user does not need real-time availability information for a quantity of one or greater, then the process flow continues to step 1180.

If, however, the user would like to check for real-time availability information, then the process flow continues to step 1140. In so doing, once the customized selections and quantities have been selected, availabilities for the selected quantity of the customized selections are requested (step 1140), input into the Scheduling & Availability component 134 (step 1150) for generating real-time availability messages (step 1160), and the real-time availability message and/or supply line availability of the customized configuration are viewed by the user (step 1170).

The user must then determine whether or not the availability messages are satisfactory (step 1180). These availability messages may or may not have been checked for real-time availability as discussed above. In step 1180, if it is determined that the customized selection availability messages are satisfactory, then the process flow continues to the shopping cart (step 1190). However, wherein the customized selection availability messages are not satisfactory to the user, whether these availability messages have been checked for real-time availability and/or supply line availability or not, the user (i.e., entitled customer, non-entitled customer, business partner, or internal sales staff and administrative support) may either exit the system (step 1200), continue to browse the catalog (step 1090), or reconfigure the shopping experience (step 1210).

Further, wherein the current sales session is by TeleSales Representative or the user is an internal sales and administrative support staffs, the user may additionally view distributor Finished Goods Inventory (FGI) availability if the seller's availability is not satisfactory to the customer or business partner (step 1500). This availability information is provided from the distributor to the seller on a periodic basis. In this aspect, referring to FIG. 2D, it must first be determined whether the FGI is available (step 1510). If the FGI is not available, the process flow reconfigures the product or service (step 1210). If, however, the FGI is available, and the availability is satisfactory, the seller executes their buy back process for the FGI (step 1520). This buy back process may include purchasing the FGI back from the distributor, dropping the order onto the distributor for shipment (seller retaining the billing responsibility), or as specified within their contract. Once the buy back process is executed, the order is completed (step 1530), and the buy back order processed (step 1540). The system is then exited (step 1200).

It should be appreciated that in the browse process (step 1090), the process flow goes back to the view appropriate catalog steps (steps 2020 and 3020), and the process flow repeats accordingly. In the reconfigure the product or service process (step 1210), the process flow goes back to the make a selection steps (steps 2030 and 3030), and the process flow repeats accordingly.

In continuing the process flow of the invention, once the user has decided to go to the shopping cart (step 1190), the user must first add the selection to the shopping cart (step 1195), and then referring to FIG. 2C, determine whether or not to continue shopping (step 1220). If the user would like to continue shopping, the process flow continues by allowing the user to browse the catalog (step 1090). Once the user has decided to stop shopping, the process continues by allowing the user to decide whether to check the availability of the entire shopping cart (step 1230). Wherein there is a saved shopping cart (step 1215), this step of the process flow may include the need for opening the saved shopping cart (step 1225).

In step 1230, if the user wants to check the availability of the entire shopping cart, availability messages for all selected quantities within the shopping cart are requested (step 1240) and input into the Scheduling & Availability component 134 (step 1250). Real-time availability messages are then generated for all selections within the shopping cart (step 1260), and are expressed in either lead time availability or supply line availability (net available supply quantities) depending upon the user type. These real-time availability messages in the shopping cart component 126 are viewed by users (step 1270). Again, the request for real-time availability is transmitted from the commerce engine to the scheduling engine, which then returns a schedule date that is translated to a lead time and then to an availability message.

The user must then decide whether to buy the viewed items within the shopping cart (step 1280). If the user does not want to buy at this time, the process flow continues by determining whether the shopping cart is to be saved at this time (step 1290). If the user does not want to save the shopping cart, the system is exited (step 1200). However, if the user would like to save the shopping cart, the process continues by saving the shopping cart (step 1295). It is then determined whether or not the user would like to exit the current session (step 1297), and if so, the process flow continues to the exit process (step 1200). However, once the shopping cart has been saved, if the user does not want to exit the current session, then the process flow repeats back to step 2005, such that, the user does not need to relog onto the present system. Of course, wherein the user has exited the system, such user may reenter the system of the invention by once again starting a session (step 1000 of FIG. 2A), and repeating the process flow steps of the invention.

In the event the user would like to purchase the available items in the shopping cart (step 1280), the user must then provide shipping information (step 1300). It is at this point that the user must decide whether or not to view the lead time to arrival availability in accordance with the results of the invention (as compared to lead time to shipment availability which is the default) (step 1310). If the lead time to arrival availability is not required, the customer completes the order (1320), and submits the shopping cart for processing (1330) to the ERP Engine 112 and Order Management component 130, and decrements available supply in the Scheduling and Availability component 134. If, however, the user would like to know the lead time to arrival availability information, a request for real-time availability is made (step 1340). The request is transmitted from the commerce engine to the scheduling engine (step 1350) for generating a schedule date which is translated to a lead time and/or a supply line availability information, and then to an availability message (step 1360) for viewing by the user (step 1370).

In accordance with the process flow, the user must then determine whether this lead time to arrival availability message is acceptable (step 1380). If the lead time to arrival availability message is acceptable, the user completes the order (step 1320) and submits the order to the shopping cart for processing (step 1330) to the ERP Engine 112 and Order Management component 130, and decrements available supply in the Scheduling and Availability component 134. However, if the user does not accept the lead time to arrival availability message, the user may alternatively select a faster route of transportation (step 1390), browse the catalog (step 1090), go to the save shopping cart process (step 1290), reconfiguring the selections (step 1210), or exiting the system (step 1200). Additionally, wherein the user is an internal sales staff and administrative support, this type of user may further view the distributor inventory of FGI at this point of the process flow for ordering (steps 1500-1540).

As shown in FIG. 2E, the Scheduling and Availability component 134 is initiated (step 1600) for converting a schedule date to a lead time availability message (step 1610). Once this is accomplished the user type is then determined, particularly by determining if the user is a business partner, internal sales and administrative support staffs (step 1620). If the user is not one of these types of users, then the process flow repeats back to step 3020 for viewing the appropriate catalog based on the customer or user type. However, if it is determined that the user is a business partner, internal sales and administrative support staff, then the process flow continues by providing supply line availability information for such user (step 1630). It is next determined if the user is an internal sales and administrative support staff (step 1640), and if not, the process flow repeats back to step 3020. If the user is an internal sales and administrative support staff, then the process flow continues by providing source of supply information for such user (step 1650). Once this information is provided, the process flow repeats back to step 3020 for viewing the appropriate catalog based on user type.

Referring now to the diagram illustrations of the availability messages viewed by users of the invention, FIG. 3 illustrates a diagram 300 of a static display of availability comprising a batch availability message that is viewed by all types of users of the invention. This batch availability diagram shows a batch availability message 310 (“msg”) to the user relating to a batch quantity of 1 (one) or statistically going rate that is derived from the Scheduling Engine 114 and Planning component 132 response and then translated from the properties file within the Commerce Engine. After configuration selections have been made, a drop down window 320 can be displayed by invoking the drop down menu. This drop down window 320 shows messages of availability supporting the overall message or each building block (“BB”) and/or option component (“Op”). Once the user decides to check real-time availability of the desired quantity of one or greater of a selected item, the user will be shown a real-time availability message for such selection. These real-time availability messages will vary depending on the user type.

Entitled and non-entitled customers will be able to view a real-time availability message as shown in the diagram 400 of FIG. 4. In this diagram, the real-time availability message 425 shows the requested quantity of the selected item (“required”), whether the item be a product and/or service, along with the currently available (i.e., real-time) quantity of such item. This real-time availability message showing the currently available quantity of the selected item has been converted from a schedule date to a lead time in days or weeks. Similar to the FIG. 3 explanation, displayed to the customer is the availability message 410, along with the drop down window 420. The drop down window 420 shows the customer the real-time availability messages at sales building block or option levels for allowing the customer to identify which building blocks or options are extending the availability of the user's selections from the catalog. It should be appreciated that between the entitled and non-entitled customers, the entitled customer is able to view improved availability above and beyond that viewed by the non-entitled customer since the entitled customer has a relationship, typically a contractual relationship, with the seller and may have a higher tier within the Scheduling Engine 114 based on parameters within the Planning component 134.

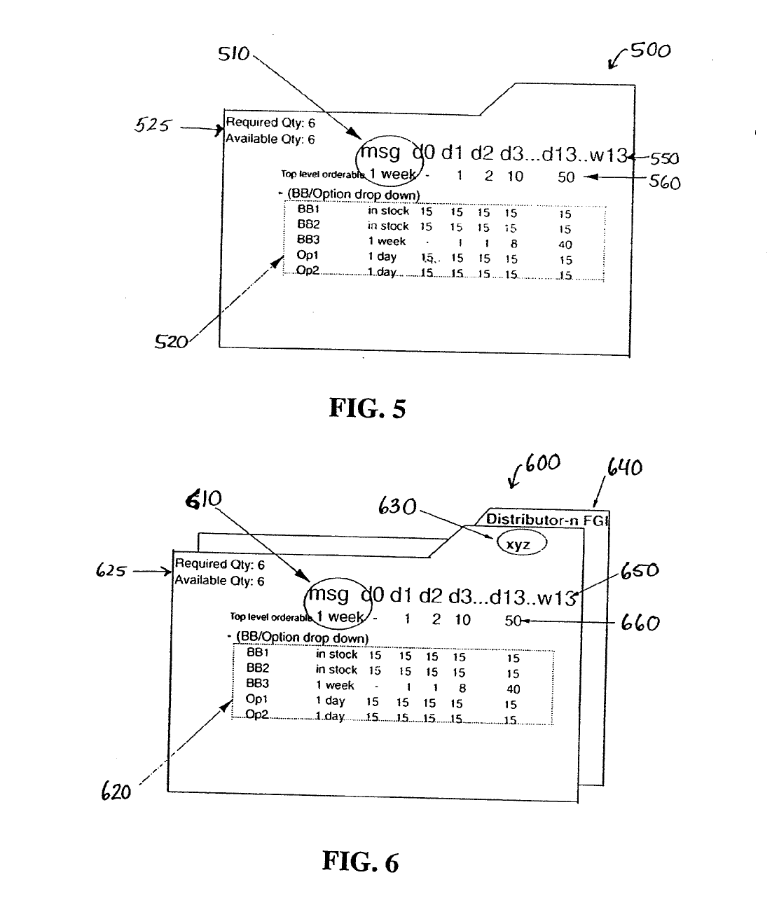

FIG. 5 illustrates a diagram 500 of a business partner's view of real-time availability in accordance with the invention. The business partner is able to view a more enhanced real-time availability screen as compared to the entitled and non-entitled customers. In particular, business partners are also offered net available supply line information over the seller's supply planning horizon 550 as contained within the scheduling engine in addition to the screen viewed by customers. For example, the planning horizon 550 of FIG. 5 shows a number of daily buckets of the seller's supply planning horizon followed by several weekly buckets. Specifically for this illustration, there are 14 daily buckets to show near-term availability followed by 11 weekly buckets to display mid-term availability for a total of 13 weeks worth of information (planning horizon). Planning horizons may vary by implementation. This level of information is essential for placing orders with large multiples, and provides detailed information concerning constrained building blocks and diagnostics for alternatives. Further, a calculated maximum available supply 560 of the selected item is generated from the requested quantity query, whereby these maximum available supplies 560 are broken down to availability based on the various buckets of the seller's supply planning horizon 550.

The internal sales and administrative support users of the invention are able to view all that the business partner views, as well as the source of supply indicator 630 shown in diagram 600 of FIG. 6. The scheduling engine determines this source of supply indicator. The internal sales and administrative support users can also view distributor Finished Goods Inventory (FGI) quantities that are held at the seller's distributor locations. In so doing, when the availability is calculated relative to lead time to shipment, insight is provided into transit times (e.g., national, international, customs clearance, etc.), which provides the internal sales and administrative support staffs with the opportunity to up-sell premium transportation. Additionally, if at least one distributor has the requested selected item as FGI, the internal sales and administrative support users can select the appropriate distributor folder tabs to view their availability. This distributor folder of FGI shows on hand availability at the top orderable level (i.e., the selected item), and preferably at the building block or option level.

It should be appreciated that components of the present invention may be embodied as a computer program product stored on a program storage device. These program storage devices may be devised, made and used as a component of a machine that utilizes optics, magnetic properties and/or electronics to perform certain of the method steps of the present invention. Such program storage devices may include, but are not limited to, magnetic media such as diskettes or computer hard drives, magnetic tapes, optical disks, Read Only Memory (ROM), floppy disks, semiconductor chips and the like. A computer readable program code means in known source code may be employed to convert certain of the method steps described below. This computer readable program code contains instructions embodied in tangible media, such as floppy disks, CD-ROMS, hard drives, or any other computer-readable storage medium, wherein, when the computer program code is loaded into and executed by a computer, the computer becomes an apparatus for practicing the invention.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method for providing sales offerings availability messages comprising: identifying a user type;
providing a catalog appropriate for said user type;
selecting a quantity of a sales offering from said catalog;
providing availability data feeds;
generating a sales offering availability message for said selected quantity of said sales offering by utilizing said user type and said availability data feeds;
transmitting said sales offering availability message to a commerce component; and
viewing said sales offering availability message in said commerce component.

2. The method of claim 1 wherein said user type is selected from the group consisting of a non-entitled customer, an entitled customer, a business partner, a distributor, a sales staff and an administrative support staff.

3. The method of claim 2 wherein said user type comprises said non-entitled customer, said catalog comprises a public catalog.

4. The method of claim 2 wherein said user type is selected from the group consisting of said entitled customer, said business partner, said sales staff and said administrative support staff, said catalog is selected from the group consisting of a customized entitled catalog and a public catalog.

5. The method of claim 4 wherein said business partner, said sales staff and said administrative support staff are further able to view net available supply lines over a seller's supply planning horizon.

6. The method of claim 5 wherein said sales staff and said administrative support staff are further able to view a source of supply indicator, and net distributor Finished Goods Inventory quantities at distributor locations.

7. The method of claim 1 wherein said catalog is provided over a Web, said method further comprising a user of said user type viewing said catalog on said Web, selecting said quantity, and viewing said sales offering availability message based on said user type.

8. The method of claim 1 wherein said catalog is provided by telesales, said method further comprising a telesales representative viewing said catalog based on said user type for assisting a user of said user type, whereby said user determines said quantity to select from said catalog, and said telesales representative views said sales offering availability message in said commerce component and translates said sales offering availability message to said user.

9. The method of claim 1 wherein said sales offering is selected from the group consisting of a product, a service and combinations thereof.

10. The method of claim 1 wherein said availability data feeds are selected from the group consisting of real-time availability data feeds, batch availability data feeds, and combinations thereof.

11. The method of claim 10 wherein said availability data feeds comprise real-time availability data feeds, said sales offering availability message comprises a real-time sales offering availability message.

12. The method of claim 1 wherein depending upon said user type, said sales offering availability message is viewed in a display selected from the group consisting of lead time availability and supply line availability.

13. The method of claim 1 wherein said step of generating said sales offering availability message comprises:
requesting an availability message of said selected quantity of said sales offering;
determining a schedule date in response to said request using said availability data feeds; and
converting said schedule date to generate said sales offering availability message.

14. The method of claim 13 wherein said steps further comprise: requesting said availability message of said selected quantity of said sales offering within a commerce component;
transmitting said request for said availability message from said commerce component to a scheduling component;
receiving said availability data feeds within said scheduling component;
determining said schedule date in response to said request within said scheduling component using said availability data feeds;
transmitting said schedule date from said scheduling component to said commerce component; and
converting said schedule date to generate said sales offering availability message within said commerce component.

15. The method of claim 13 wherein said step of converting said schedule date further comprises:
initiating a scheduling component;
determining said user type;
providing supply line availability information if it is determined that said user type is selected from the group consisting of a business partner, a sales staff and an administrative support staff.

16. The method of claim 15 wherein said steps further comprise:
providing source of supply information if it is determined that said user type is selected from the group consisting of said sales staff and said administrative support staff.

17. The method of claim 1 further including the steps of:
configuring a customized solution for said sales offering availability message;
generating a second sales offering availability message for said customized solution for said sales offering availability message by utilizing said user type and said availability data feeds;
transmitting said second sales offering availability message to said catalog; and
viewing said second sales offering availability message in said catalog.

18. The method of claim 1 further including the steps of:
saving said sales offering availability message within a shopping cart;
requesting an availability message for all sales offering availability messages saved within said shopping cart;
generating updated sales offering availability messages for all said sales offering availability messages saved within said shopping cart;
transmitting said updated sales offering availability messages to said commerce component; and
viewing said updated sales offering availability messages in said commerce component.

19. A system for providing sales offerings availability messages comprising:
a catalog component for providing a catalog based on a user type;
a commerce component for requesting an availability message of a selected quantity of a sales offering; and
a scheduling component for receiving availability data feeds and said requested availability message,
wherein said scheduling component determines a schedule date in response to said request using said availability data feeds and transmits said schedule date to said commerce component, whereby said commerce component converts said schedule date to a sales offering availability message for said selected quantity of said sales offering, said sales offering availability message being displayed within said commerce component.

20. A program storage device readable by a machine, tangibly embodying a program of instructions executable by the machine to perform method steps for providing sales offerings availability messages, said method steps comprising:
identifying a user type;
providing a catalog appropriate for said user type;
selecting a quantity of a sales offering from said catalog;
providing availability data feeds;
generating a sales offering availability message for said selected quantity of said sales offering by utilizing said user type and said availability data feeds;
transmitting said sales offering availability message to said commerce component; and
viewing said sales offering availability message in said commerce component.

21. The program storage device of claim 20 wherein said availability data feeds are selected from the group consisting of real-time availability data feeds, batch availability data feeds, and combinations thereof.

22. The program storage device of claim 20 wherein depending upon said user type, said sales offering availability message is viewed in a display selected from the group consisting of lead time availability and supply line availability.

23. The program storage device of claim 20 wherein said steps further comprise:
requesting said availability message of said selected quantity of said sales offering within a commerce component;
transmitting said request for said availability message from said commerce component to a scheduling component;
receiving said availability data feeds within said scheduling component;
determining said schedule date in response to said request within said scheduling component using said availability data feeds;
transmitting said schedule date from said scheduling component to said commerce component; and
converting said schedule date to generate said sales offering availability message within said commerce component.

24. The program storage device of claim 23 wherein said step of converting said schedule date further comprises:
initiating a scheduling component;
determining said user type;
providing supply line availability information if it is determined that said user type is selected from the group consisting of a business partner, a sales staff and an administrative support staff.

25. The program storage device of claim 24 wherein said steps further comprise:
providing source of supply information if it is determined that said user type is selected from the group consisting of said sales staff and said administrative support staff.

26. The program storage device of claim 20 further including the steps of:
configuring a customized solution for said sales offering availability message;
generating a second sales offering availability message for said customized solution for said sales offering availability message by utilizing said user type and said availability data feeds;
transmitting said second sales offering availability message to said commerce component; and
viewing said second sales offering availability message in said commerce component.

27. The program storage device of claim 20 further including the steps of:
saving said sales offering availability message within a shopping cart;
requesting an availability message for all sales offering availability messages saved within said shopping cart;
generating updated sales offering availability messages for all said sales offering availability messages saved within said shopping cart;
transmitting said updated sales offering availability messages to said commerce component; and
viewing said updated sales offering availability messages in said commerce component.
